(19) United States
(12) Patent Application Publication
(10) Pub. No.: US 2021/0331461 A1
(43) Pub. Date: Oct. 28, 2021

(54) COMPARISONS OF HEATING ELEMENT POWER LEVEL PARAMETERS

(71) Applicant: HEWLETT-PACKARD DEVELOPMENT COMPANY, L.P., Spring, TX (US)

(72) Inventors: Jody L. Clayburn, Vancouver, WA (US); Robert Yraceburu, Vancouver, WA (US); Daniel James Magnusson, Vancouver, WA (US)

(21) Appl. No.: 16/499,944

(22) PCT Filed: Jul. 13, 2018
(86) PCT No.: PCT/US2018/042131

§ 371 Date: Oct. 1, 2019

(51) Int. Cl. B41F 23/04; B41F 23/08; B41J 11/00

(52) U.S. Cl. CPC B41F 23/0459; B41J 11/00244; B41J 11/00242; B41F 23/08

(57) ABSTRACT

In some examples, a media conditioner includes a conveying component to convey a sheet of printable media, a first heating element to heat a first portion of the conveying component, a second heating element to heat a second portion of the conveying component, and a controller. The controller is to provide a variable first power level to the first heating element and a variable second power level to the second heating element to cause the first and second heating elements to generate heat. In addition, the controller is to determine a first parameter based on the first power level and to determine a second parameter based on the second power level. The controller is also to produce a result indicator based on a result of a comparison between the first parameter and the second parameter.

### BACKGROUND

Printing images or text on printable media in a printer includes various media processing activities, including pick-up, delivery to a print engine, printing, and conditioning of sheets of printable media. Conditioning involves heating and pressing the sheets through or past a heated pressure roller (HPR) to remove liquid (for printers using liquid ink), to remove wrinkles or curvature, or to reform or flatten fibers in the sheets.

### BRIEF DESCRIPTION OF THE DRAWINGS

Various examples are described below referring to the following figures:

FIG. 1 shows a media printing system, which includes a media conditioner in accordance with various examples;

FIG. 2 shows a partially schematic view of the media conditioner of FIG. 1, which includes heat lamps, a heated belt, and a controller in accordance with various examples;

FIG. 3 shows a bottom view of the heat lamps and a heated belt of FIG. 2 in accordance with various examples;

FIG. 4 shows a schematic view of the media conditioner of FIG. 2 in accordance with various examples;

FIG. 5 shows a flow diagram of a method of operating the media conditioner of FIG. 2 in accordance with various examples; and

FIG. 6 shows a flow diagram of a method of operating the media conditioner of FIG. 2 in accordance with various examples.

### DETAILED DESCRIPTION

In the figures, certain features and components disclosed herein may be shown exaggerated in scale or in somewhat schematic form, and some details of certain elements may not be shown in the interest of clarity and conciseness. In some of the figures, in order to improve clarity and conciseness, a component or an aspect of a component may be omitted.

In the following discussion and in the claims, the terms “including” and “comprising” are used in an open-ended fashion, and thus should be interpreted to mean “including, but not limited to . . . .” Also, the term “couple” or “couples” is intended to be broad enough to encompass both indirect and direct connections. Thus, if a first device couples to a second device, that connection may be through a direct connection or through an indirect connection via other devices, components, and connections. In addition, as used herein, the terms “axial” and “axially” generally refer to positions along or parallel to a central or longitudinal axis (e.g., a central axis of a body or a port). As used herein, including in the claims, the word “or” is used in an inclusive manner. For example, “A or B” means any of the following: “A” alone, “B” alone, or both “A” and “B.”

In various examples, a media printing system includes a media conditioner coupled to a printer apparatus, which may also be called a print engine. The print engine is capable of forming an image on a sheet of printable media by a technology such as inkjet, laser, or digital offset, as examples. The media conditioner is positioned to receive sequentially sheets of printed media from the printing device after images are formed on the sheets. The images may include text, figures, or photographic images and may be black, monochrome, or multi-color, as examples. In various examples, conditioning the media includes heating the media, removing an ink solvent, melting an ink, or improving the flatness of the media. In various examples, the media printing system may also be called a printer, an all-in-one printer, or a photocopier. The media conditioner includes a conveying component to conductively heat and move a sheet of printable media and a first heating element and a second heating element to heat the conveying component. The conveying component may be a roller or a belt, as examples, and the heating elements may be arranged to heat different portions of the belt. A controller for the media conditioner is to provide separate power levels to the heating elements based on measurements from temperature sensors that monitor the conveying component. While active, the controller is to maintain the belt at a temperature set-point.

A complication may arise if, for example, one of the temperature sensors is misaligned. The sensor might detect a temperature that is lower than the actual belt temperature. This erroneously low temperature reading would be received by the controller. In this scenario, the controller is likely to provide more—or even too much—power to a heating element in an effort to drive the reading of the sensor up to the temperature set-point. The belt or a portion of the belt may become overheated, hotter than is desired or useful for conditioning the printable media.

To reduce the potential for this undesired outcome, in addition to other functions, the controller of the media conditioner is provided with functionality to compare the power levels of the heaters, or another set of parameters associated with the power levels, to evaluate the performance of the media conditioner. For example, the controller may calculate a running average of the power level that is provided to the first heating element over a time period and to calculate a running average of the separate power level that is provided to the second heating element over the same time period. The controller is to calculate an arithmetic difference between these two power levels and to compare that difference against a predetermined threshold value. The controller is to perform a task if the difference is greater than the threshold value. The task may include, as examples, refusing to accept printable media, shutting-down, or sending a notification. In some examples, arithmetic differences are calculated for each reading of the two power levels, and the multiple values of these power level differences are then averaged and evaluated against the threshold value. Other comparisons may be useful. In a scenario in which both temperature sensors are fully functional, but a temperature sensor is misaligned, a comparison of readings from the temperature sensors might not reveal the misalignment. In some examples, evaluating the relative power levels of the heaters, as described, could indicate that a heating problem exists, allowing the issue to be addressed. The method disclosed herein can evaluate the performance of multiple heaters without consideration of temperature readings. More examples of media conditioners for media printing systems and techniques of evaluating them are described below.

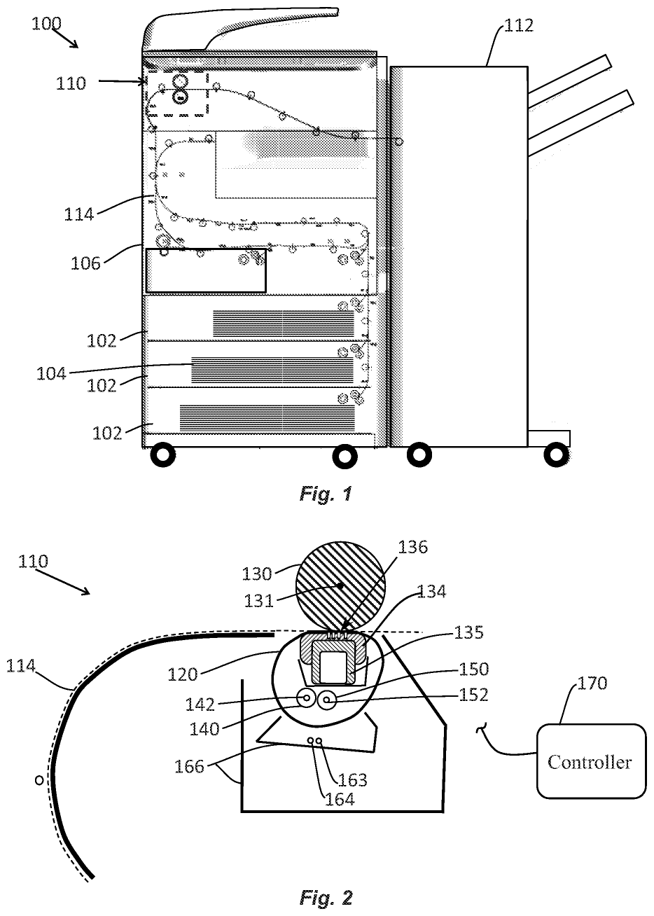

The example of FIG. 1 shows a media printing system 100 that includes multiple media trays 102 to hold multiple sheets of printable media 104, a print engine 106, a media conditioner 110, and a finisher 112. A media path 114 extends from media trays 102 to print engine 106, media conditioner 110, and finisher 112. In the separate media trays 102, the sheets of printable media may vary by face size, thickness, paper type, color, etc.

Referring now to FIG. 1 and FIG. 2, media conditioner 110 includes a first conveying component coupled to engage a second conveying component to receive, contact, heat, and convey a sheet of printable media 104. In this example, the first conveying component is a heated belt 120, and the second conveying component is a driven roller 130, which may be driven to rotate by a motor. Roller 130 extends widthwise along a central axis 131. Media conditioner 110 includes a platen 134 and a platen support structure 135 to support and guide the belt 120, a first and a second heater, a first and a second temperature sensor 163, 164, a chassis 166, and a controller 170. In this example, the heaters are radiant heaters, which include a first lamp 140 having a first heating element 142 and a second lamp 150 having a second heating element 152. Lamps 140, 150 are located within belt 120 to heat the belt by thermal radiation from the inside. During operation, roller 130 is conductively heated by contact with belt 120, and media, when present, is to be heated by contact with belt 120 and roller 130. In some examples, heating elements 142, 152 may be disposed outside belt 120. Lamps 140, 150 may be halogen-type lamps, but other types of lamps or other types of heating elements may be used in various other examples to heat belt 120 or roller 130.

Belt 120 and roller 130 contact and press against each other along a nip region 136 to receive and convey the media. Nip region 136 extends along the shared width of belt 120 and roller 130. During operation, rotational movement of the roller 130 drives the belt 120 to rotate, with or without media, in between the roller 130 and the belt 120. First and second temperature sensors 163, 164 are non-contacting thermistors located outside and below belt 120. Other examples may include another form of non-contact temperature sensor or may include a contact temperature sensor located in an appropriate position.

Some examples of a media conditioner 110 include temperature sensors to monitor the temperatures at locations along the width of the second conveying component, for example roller 130. Some examples of a media conditioner may include a conveying component, such as a belt 120 or a roller 130, that is conductively heated.

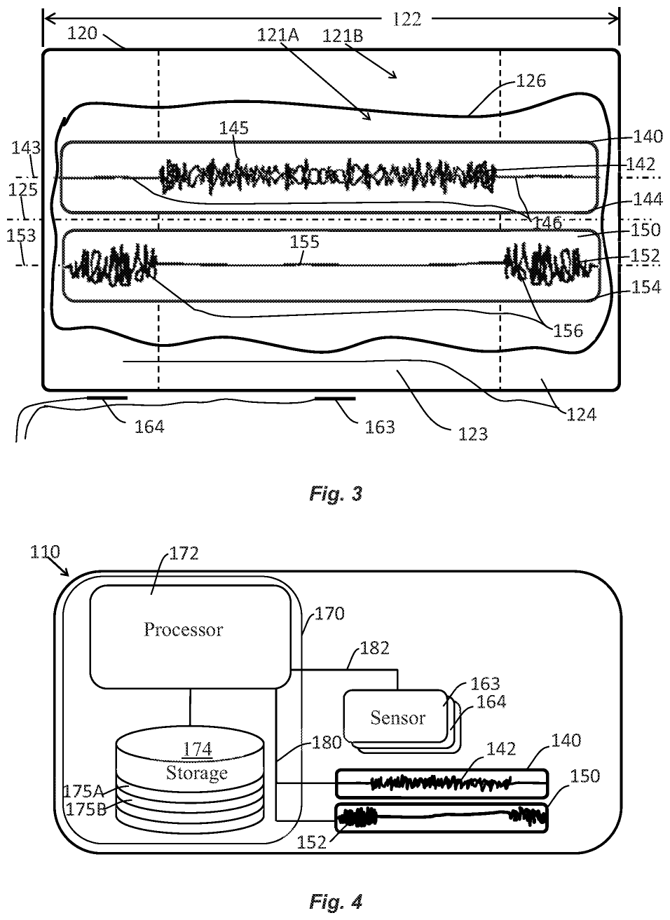

Referring now to the bottom view of FIG. 3, belt 120 is shown as if a portion were removed, creating a window 126 that exposes an interior region of the belt, making lamps 140, 150 visible. Belt 120 includes an inner surface 121A, an outer surface 121B, and a width 122, which can be considered to include a first or inner portion 123 and a second or outer portion(s) 124. Belt 120 wraps around an axis 125 that extends widthwise. Outer portion 124 includes the two sides of the belt that extend in opposite directions from inner portion 123. Thus, these “inner” and “outer” portions 123, 124 are defined along width 122 and are distinguished by vertical, dashed lines in FIG. 3. A portion or the entirety of first heating element 142 of lamp 140 and a portion or the entirety of second heating element 152 of lamp 150 extend axially within the loop formed by belt 120, extending parallel to width 122. Belt 120 is thus to travel in its loop around heating elements 142, 152.

Still referring to FIG. 3, the first lamp 140 and its first heating element 142 extend lengthwise along a longitudinal axis 143 within a tubular bulb 144, and the second lamp 150 and its second heating element 152 extend lengthwise along a longitudinal axis 153 within a tubular bulb 154. Lamp axes 143, 153 extend parallel to axis 125 of belt 120 and axis 131 of roller 130. (Roller axis 131 is visible in FIG. 2.) When energized, a central portion 145 of first heating element 142 is active and producing heat, while the outer portion(s) 146 (e.g., beyond each end of central portion 145) produces little or negligible heat. When energized, the axially central portion 155 of second heating element 152 produces little or negligible heat; while the outer portion(s) 156 (e.g., beyond each end of central portion 155), of second heating element 152 are active, and producing heat. Thus, first heating element 142 may also be called an inner heating element, and second heating element 152 may also be called an outer heating element for width 122 of belt 120.

The central, active portion 145 of inner heating element 142 is sized and positioned to heat the belt's inner portion 123 along the belt's inner surface 121A, and the first temperature sensor 163 is positioned to measure temperature on the outer surface 121B of inner portion 123. The outer, active portion 156 of heating element 152 of lamp 150 is sized and positioned to heat the belt's outer portion 124 along the belt's inner surface 121A, and the second temperature sensor 164 is positioned to measure temperature on the outer surface 121B of outer portion 124. In some examples, inner portion 123 and the first heating element 142 extend along 60% of the belt's width 122, and outer portion 124 and second heating element 152 extend along 40% of the belt's width. A size ratio of 60:40 thus may exist for the inner and outer portions 123, 124 and between the effective heating lengths of lamps 140, 150. In some examples, the ratio is greater than 60:40, and in some examples the ratio is less than 60:40. In some examples, the ratio is greater than or equal to 50:50 and less than or equal to 90:10. Other ratios are possible.

As shown in FIG. 4, controller 170 includes a processor 172, storage 174, electrical couplings 180 for heat lamps 140, 150, and electrical couplings 182 for sensors (of which temperature sensors 163, 164 are examples). In various examples, controller 170 may be assigned to govern the operation of media printing system 100 as a whole or may be assigned to govern media conditioner 110 alone, being coupled to communicate with another controller of media printing system 100. In some examples, controller 170 shares components, such as storage 174, with another controller of media printing system 100.

Storage 174 is a computer-readable storage medium storing, for example, machine executable code to be executed by processor 172. In various examples, machine executable code may also be called machine readable instructions or computer executable code. The machine executable code stored in storage 174 includes code 175A and code 175B. Code 175A, when executed by controller 170, is to cause controller 170 (e.g., its processor 172) to provide a first power level to first lamp 140 and its heating element 142 and to provide a second power level to the second lamp 150 and its heating element 152, and to cause the first and second heating elements 142, 152 to generate heat to heat the belt 120. In addition, code 175A is to cause controller 170 to monitor signals or data from sensors 163, 164 to modulate the power supplied to heating elements 142, 152 and maintain the temperature of belt 120 at a desired temperature set-point. The first and second power levels are variable. During operation, controller 170 is to provide separate first and second power level signals and may vary the signals to vary the first and second power levels provided to heating elements 142, 152, respectively. In an example, the power level signals are pulse-width-modulated (PWM) signals. Whether controller 170 uses a PWM signal, another analog power level signal, or a digital power level signal, the signals may vary incrementally or smoothly from zero to 100%. The value of 100% power refers to the maximum power that the heating element can accept or the maximum power that the system can provide, whichever is lower. Broadly, the term “power level” will refer to the electrical power available to a heating element or used by a heating element, or it will refer to the power level signal for controlling the electrical power to a heating element. Although electrical couplings 180 are simply shown as a direct connection between controller 170 and heating lamps 140, 150, in various examples electrical couplings 180 connect the controller 170 to a power supply that feeds heating lamps 140, 150.

Machine executable code 175B in storage 174, when executed by controller 170, is to cause controller 170 (e.g., its processor 172) to evaluate the performance of heating elements 142, 152. In this process, the controller is to determine a first parameter based on the first power level and to determine a second parameter based on the second power level. The first parameter is to be indicative of the performance of the first heating element 142, and the second parameter is to be indicative of the performance of the second heating element 152. The first and second parameters may be selected from among a group of parameters associated with power level including, but not limited to: the power level signal of the controller, the power level received by the heating element, the current received by the heating element, a voltage across a heating element, and the temperature of the heating element, as examples. In various examples, media conditioner 110 has more or fewer of these or related parameters available for analysis by controller 170. For ease of conversation, a discussion given below will address examples in which the parameters evaluated by controller 170 while executing code 1756 include real-time values of a power level for the heating elements. The power levels are based on the needs that controller 170 perceives based on data from sensors 163, 164 according to code 175A, as discussed above. The methodology that is described is applicable to other power level parameters, such as those mentioned in this paragraph.

After controller 170 determines first and second parameters based on the power levels of the heater elements, the controller is to produce a result indicator based on a result of a comparison between the first and second parameters. The result indicator is, as examples, a signal from controller 170 that is initiated or a signal from controller 170 is stopped. The result indicator may communicate a command to a component in media conditioner 110 or to a component in media printing system 100. The command may be to stop or pause functioning or to perform an action. For example, the media conditioner may stop receipt of printable media in response to the result indicator. In some examples, the result indicator includes a signal that causes print engine 106 to stop processing sheets of printable media. The result indicator may provide indication to a user. In some examples, the result indicator causes the media conditioner (e.g., controller 170) to set to zero the power level (e.g., a PWM signal) of heating element 142 or of heating element 152. In several of these examples, the controller 170 is to transmit the result indicator to a component that is external to the controller.

As an example, a comparison of parameters may be based on the first and second power levels for the heating elements 142, 152 of media conditioner 110 and may be calculated as show here using the difference between real-time values of those power levels:

PL₁−PL₂<−ΔPLₘₐₓ

Or

PL₁−PL₂>ΔPLₘₐₓ 1

where: PL₁ is the power level of first heating element 142 of first heating lamp 140;

PL₂ is the power level of second heating element 152 of second heating lamp 150; and

ΔPLₘₐₓ is a threshold value equivalent to a maximum desired or maximum allowable difference between the power levels of the first and second heating elements.

Keeping the arithmetic difference between PL₁ and PL₂ less than the threshold value ΔPLₘₐₓ is a goal of code 175B in this example. If a result of Expression 1 is true then the magnitude of the difference between power levels PL₁ and PL₂ is too large as compared to the threshold value, which is a failing condition for the operation of media conditioner 110. If instead, a result of following expression is true, then a “passing condition” has been determined for of media conditioner 110. This condition indicates that the power levels provided to heating elements 142, 152 are acceptably balanced, and temperature sensors 163, 164 are likely to be properly reading belt temperatures. The passing condition may be expressed as:

−ΔPLₘₐₓ<PL₁−PL₂<ΔPLₘₐₓ 2

The real-time values of PL₁ and PL₂ may be evaluated as single values or as averages, such as running averages calculated over a moving time period, as examples.

In the present example, the power levels for the heaters have been described in units of percent and may vary incrementally or smoothly from zero to 100% of a maximum power. Thus, a difference between power levels, such as the threshold value, ΔPLₘₐₓ, may be expressed as a percent. Further, the threshold value, ΔPLₘₐₓ, may be a constant value as exemplified here:

ΔPLₘₐₓ=35% 3

In other examples, the threshold value is a constant value selected from the range: 5% to 40%. In still other examples, the threshold value is a constant value less than 5% or greater than 40%. In some of these examples, the threshold value is less than 60%.

The threshold value, ΔPLₘₐₓ, may be evaluated based on an anticipated difference in power levels for a normal operating condition for media conditioner 110, which is identified by the variable: ΔPLₙₒᵣₘₐₗ, in the next two expressions:

ΔPLₘₐₓ=ΔPLₙₒᵣₘₐₗ+20% 4

Like the 35% in Expression 3, the 20% in Expression 4 is provided as an example, and may be selected to be another value.

ΔPLₙₒᵣₘₐₗ=(PL₁−PL₂)ₙₒᵣₘₐₗ 5

The first and second power level values of PL_{1,normai} and PL_{2, normal} may be single values or may be averages, such as averages evaluated during a selected time period or averages of a selected number of data points collected earlier, as examples.

Whether using Expression 4 or 5 or another evaluation, the threshold value, ΔPLₘₐₓ, may be determined based on thermodynamic or heat transfer parameters related to belt 120, roller 130, heating lamps 140, 150, another component, or the media (e.g., thickness, material properties, etc.), as examples. The threshold value may be determined based on the feed rate of media. The difference in power levels for a normal operating condition, ΔPLₙₒᵣₘₐₗ, may be based on a design condition, such as the heating rate of the heat lamps 140, 150 and their heating elements 142, 152. Lamps 140, 150 and their heating rates may be selected based on the size ratio selected for the inner and outer portions 123, 124 of the width of belt 120 (FIG. 3). The difference in power levels for a normal operating condition may be based on a potential for greater heat loss that may exist on one portion or another of the belt's width. As an example of these concepts, if the size ratio for inner and outer portions 123, 124 is close to or equal to 50:50 and both portions 123, 124 experience similar heat loss, then the difference in power levels for a normal operating condition, ΔPLₙₒᵣₘₐₗ, may be a relatively small value. Alternatively, if the size ratio for inner and outer portions 123, 124 is significantly different than 50:50, or if one of the portions 123, 124 experiences greater heat loss than another portion does, perhaps due to greater contact with air, then the difference in power levels for a normal operating condition, ΔPLₙₒᵣₘₐₗ, may be a relatively larger value.

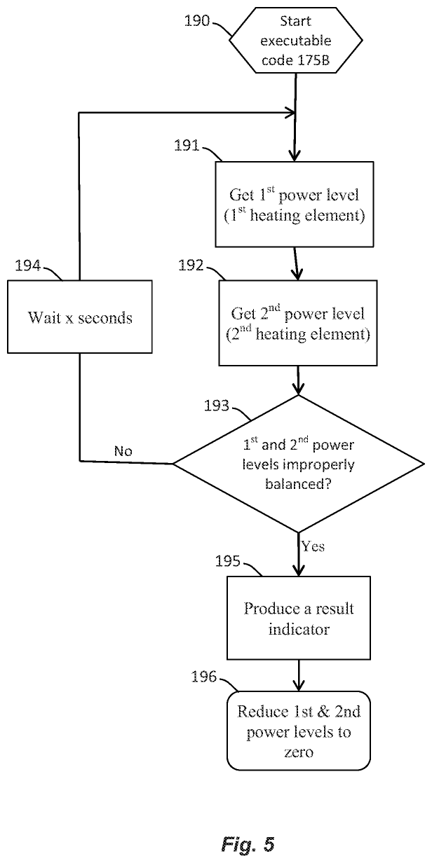

Referring to FIG. 5, an example of controller 170 evaluating the performance of heating elements 142, 152 is depicted. During operation, at block 190, controller 170 is to start executing machine executable code 175B. At block 191, the current value of the first power level is to be retrieved or measured, and at block 192, the current value of the second power level is to be retrieved or measured. The values of power levels may be, for example, any of the types of values discussed above. At block 193, controller 170 is to perform a comparison between the first and second power levels to determine whether they are improperly balanced or proportioned, as may be accomplished by selecting and calculating Expressions 1, 3, 4 and 5, for example. If the result of block 193 or Expression 1 is false (“No”), then controller 170 determines that the power levels provided to the first and second heating elements 142, 152 are properly balanced, and operation of media conditioner 110 and printing system 100 continues. Controller 170 is to wait for a predetermined length of time (e.g., on the order of seconds or milliseconds) at block 194, and then to begin the comparison again from block 191. If the result of block 193 or Expression 1 is true (“Yes”), then the power levels provided to the first and second heating elements 142, 152 are not properly balanced, and controller 170 is to produce a result indicator at block 195. In Expression 1, the difference between the power levels exceeds a threshold value. As a consequence, at block 196, controller 170 may reduce the first and second power levels to zero or may perform any of the other actions previously mentioned. In some examples, controller 170 is to cease to produce the result indicator in response to the arithmetic difference between the first and second power level returning to a value that is equal to or less than the ΔPLₘₐₓ, the threshold value in a subsequent time period. In those examples, the operation of media conditioner 110 and system 100 may return to normal, assuming no other fault has occurred in system 100.

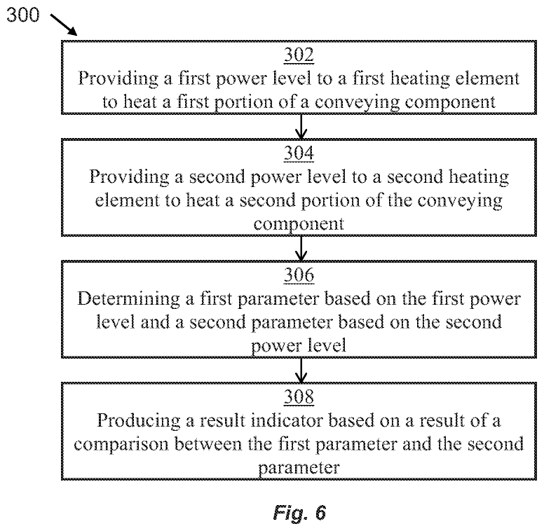

FIG. 6 presents an example of a method 300 for comparing the performance of heating elements for a media conditioner. Block 302 of method 300 includes providing a first power level to a first heating element to heat a first portion of a conveying component. Block 304 includes providing a second power level to a second heating element to heat a second portion of the conveying component. Block 306 includes determining a first parameter based on the first power level and a second parameter based on the second power level, and block 308 includes producing a result indicator based on a result of a comparison between the first parameter and the second parameter. Some implementations of method 300 include determining a temperature difference between a temperature of the first portion of the conveying component and a temperature of the second portion of the conveying component, where the result indicator is produced if the temperature difference is less than a temperature difference threshold value. Some implementations of method 300 include causing the media conditioner 110 to set the first power level or the second power level to zero after producing the result indicator. Some other implementations of method 300 may incorporate other functionalities disclosed herein. Method 300 may be implemented in media conditioner 110.

In some examples discussed thus far, methods for comparing the performance of heating elements for a media conditioner can be accomplished without regard to any temperature measurements. Expressions 1 to 5 and the method of FIG. 5 may be utilized without temperature measurements for the example that was explained.

In other examples, methods for comparing the performance of a first and a second heating element may be implemented with the additional knowledge of the temperature distribution across the heated conveying component, for example, belt 120. In general, controller 170 is to maintain a uniform temperature distribution across the width of belt 120, such that the difference in readings of the first temperature sensor 163 and second temperature sensor 164 is less than a predetermined temperature difference threshold value, using machine executable code 175A. If sensors 163, 164 have a difference greater than the threshold value, this condition may indicate that a portion of the belt has cooled too much and controller 170 may apply additional power to the corresponding heating element 142, 152 to make the belt temperature uniform again. However, if one of the temperature sensors is partially misaligned, that sensor might detect a temperature that is lower than the actual belt temperature. As a result, controller 170 may overheat a region of the belt in an effort to balance the temperature readings of sensors 163, 164. To check for this potential issue or for another cause of belt over-heating, controller 170 may implement a method for comparing the performance of a first and a second heating element, as described above.

In addition, in some examples of operating the machine executable code 175A, controller 170 is to determine a temperature difference before implementing the heating element performance comparison. For example, code 175B may cause controller 170 to determine a temperature difference between an average temperature on the belt's first portion 123 and average temperature on the belt's second portion 124. The averages may be evaluated over a time period or across a spatial distribution on belt portion 123 and on belt portion 124. In some examples, individual sets of temperature values from sensors 163, 164 may be used to calculate the temperature difference without averaging. If the calculated temperature difference is less than the temperature difference threshold value, then, for this example, the controller is to implement the heating element performance comparison, is to produce the result indicator, and may respond to it as described above.

The above discussion is meant to be illustrative of the principles and various examples of the present disclosure. Numerous variations and modifications will become apparent to those skilled in the art. It is intended that the following claims be interpreted to embrace all such variations and modifications.

What is claimed is:

1. A media conditioner comprising:
a conveying component to convey a sheet of printable media;
a first heating element to heat a first portion of the conveying component;
a second heating element to heat a second portion of the conveying component; and
a controller to provide a first power level to the first heating element and a second power level to the second heating element to cause the first and second heating elements to generate heat,
wherein the controller is to determine a first parameter based on the first power level and to determine a second parameter based on the second power level, and
wherein the controller is to produce a result indicator based on a result of a comparison between the first parameter and the second parameter.

2. The media conditioner of claim 1 wherein the first parameter is an average of the first power level, and the second parameter is an average of the second power level,
wherein the comparison includes a determination of a difference between the average of the first power level and the average of the second power level, and
wherein the controller is to produce the result indicator in response to the difference exceeding a threshold value.

3. The media conditioner of claim 1 comprising:
a first temperature sensor to measure temperature on the first portion of the conveying component; and
a second temperature sensor to measure temperature on the second portion of the conveying component,
wherein the controller is to determine a temperature difference between an average temperature on the first portion and an average temperature on the second portion, and
wherein the controller is to produce the result indicator in response to the temperature difference being less than a temperature difference threshold value.

4. The media conditioner of claim 1 wherein the controller is to transmit the result indicator external to the controller.

5. The media conditioner of claim 1 wherein the media conditioner is to set the first power level or the second power level to zero in response to the result indicator.

6. The media conditioner of claim 1 wherein the conveying component is a belt,
wherein the first and second heating elements extend within the belt,
wherein the first heating element is to heat an inner portion of a width of the belt, and
wherein the second heating element is to heat an outer portion of the width of the belt, including two sides of the belt separated by the inner portion, and
wherein the conveying component is to heat the sheet of printable media.

7. A media printing system comprising:
a print engine to form an image on a sheet of printable media; and
a media conditioner coupled to the print engine to process the sheet of printable media, the media conditioner comprising:
a conveying component to convey a sheet of printable media;
a first heating element to heat a first portion of the conveying component;
a second heating element to heat a second portion of the conveying component; and
a controller to provide a first power level to the first heating element and a second power level to the second heating element,
wherein the controller is to determine a first parameter associated with the first power level and to determine a second parameter associated with the second power level, and
wherein the controller is to produce a result indicator corresponding to a result of a comparison between the first parameter and the second parameter.

8. The media printing system of claim 7 wherein the first parameter includes an average of the first power level during a time period, and the second parameter includes an average of the second power level during the time period,
wherein the comparison includes a determination of a difference between the average of the first power level and the average of the second power level, and
wherein the controller is to produce the result indicator in response to the difference when the difference exceeds a threshold value.

9. The media printing system of claim 8 wherein the first heating element is to heat an inner portion of a width of the conveying component,
wherein the second heating element is to heat an outer portion of the width of the conveying component,
wherein the media conditioner comprises:
a first temperature sensor to measure temperature on the inner portion of the conveying component; and
a second temperature sensor to measure temperature on the outer portion of the conveying component,
wherein the controller is to determine a temperature difference between an average temperature on the inner portion of the conveying component and an average temperature on the outer portion of the conveying component, and
wherein the controller is to produce the result indicator in response to the temperature difference being less than a temperature difference threshold value.

10. The media printing system of claim 8 wherein the controller is to cease to produce the result indicator in response to the difference becoming equal to or dropping below the threshold value in a subsequent time period.

11. The media printing system of claim 7 wherein the media conditioner is to stop receipt of printable media in response to the result indicator.

12. The media printing system of claim 7 wherein the media conditioner is to receive the sheet of printable media from the print engine,
wherein the conveying component is a belt,
wherein the media conditioner includes a driven roller coupled to cause the belt to rotate, and
wherein a portion of the first heating element and a portion of the second heating element are disposed inside a path of the belt.

13. A method comprising:
providing a first power level to a first heating element to heat a first portion of a conveying component;
providing a second power level to a second heating element to heat a second portion of the conveying component;
determining a first parameter based on the first power level and a second parameter based on the second power level; and
producing a result indicator based on a result of a comparison between the first parameter and the second parameter.

14. The method of claim 13 comprising:
determining a temperature difference between a temperature of the first portion of the conveying component and a temperature of the second portion of the conveying component,
wherein producing the result indicator occurs if the temperature difference is less than a temperature difference threshold value.

15. The method of claim 13 comprising:
setting the first power level or the second power level to zero after producing the result indicator.
